(19) United States
(12) Patent Application Publication
(10) Pub. No.: US 2025/0137898 A1
(43) Pub. Date: May 1, 2025

(54) HIGH THROUGHPUT VISCOMETER AND METHODS OF USING THE SAME

(71) Applicant: Rheosense, Inc., San Ramon, CA (US)

(72) Inventor: Seong-Gi BAEK, Pleasanton, CA (US)

(21) Appl. No.: 19/011,548

(22) Filed: Jan. 6, 2025

Related U.S. Application Data
(63) Continuation-in-part of application No. PCT/US23/69729, filed on Jul. 6, 2023.
(60) Provisional application No. 63/358,811, filed on Jul. 6, 2022.

(51) Int. Cl. G01N 11/08; G01N 11/00

(52) U.S. Cl. CPC G01N 11/08; G01N 2011/002

(57) ABSTRACT

This application describes a viscosity measuring instrument that measures viscosity as a function of shear rate in a high throughput manner. The instrument may include multiple viscosity measurement sensor chips arranged in parallel so that viscosity is measured at multiple shear rates simultaneously for many samples. For example, the instrument may include multiple viscosity sensors with liquid flow channels for measuring viscosities of liquids flowing through the flow channels and multiple syringes, each outlet of which is connected to a corresponding inlet of multiple viscosity sensors. The instrument may also include a pump module with a pusher block having a mechanism to lock and unlock ends of pistons of the multiple syringes.

### RELATED APPLICATIONS

This application is a continuation-in-part application of the international patent application No. PCT/US2023/069729, filed Jul. 6, 2023, which claims the benefit of, and priority to, U.S. Provisional Patent Application Ser. No. 63/358,811, filed Jul. 6, 2022, both of which are incorporated by reference herein in their entireties.

### TECHNICAL FIELD

This application is related to viscosity measurements, in particular viscometers that measure viscosity of liquids in a high throughput manner.

### BACKGROUND

Viscometers, which allow measurement of viscosity, play an important role in scientific and industrial applications. However, the advancements in scientific research and industrial applications now demand viscometers that are more rapid and accurate than conventional viscometers.

Viscosity is a measure of resistance of liquid to flow and its value depends on the rate of deformation for Non-Newtonian liquids as described in Dynamics of Polymeric Liquids, Vol. 1, 1987 authored by R. B. Bird, R. C. Armstrong, and O. Hassager. The rate of deformation is given by a shear rate in a unit of (time)⁻¹. The viscosity measured at a known shear rate is “true” viscosity. The dependence of the true viscosity on shear rate is a viscosity curve which characterizes material and is an important factor to consider for efficient processing. But in many cases, viscosity is measured under an ill-defined test condition so that the shear rate cannot be known or calculated. Under ill-defined conditions, the measured viscosity value is only “apparent”. Since the true viscosity is measured at a known shear rate, the true viscosity is universal whereas the apparent viscosity is not. Instead, the apparent viscosity depends on the measuring system. For example, as a common practice, a torque of a spindle immersed in a sea of test liquid is measured while the spindle is being rotated at a constant speed. In this case, the torque value only yields an apparent viscosity since the test condition is ill defined and a shear rate is not known. At best, the apparent viscosity can be measured as a function of the rotational speed of the spindle. The rotational speed of the spindle can be in fact correlated with the shear rate only if “constitutive equation” for the test liquid is known. However, “constitutive equation” is not known for almost all Non-Newtonian liquids. Therefore, true viscosity cannot be measured with ill-defined test condition for most non-Newtonian liquids.

### SUMMARY

Various shortcomings of conventional viscometers are addressed by the viscometers described herein. For example, conventional viscometers that provide only apparent viscosities have been developed and used for quality controls in manufacturing and material characterization. However, because of the non-universality of the apparent viscosity measurement, a correlation of the apparent viscosity of a specific sample measured using a specific method with the true viscosity has to be found separately when needed. Development of formulation or materials often requires the true viscosity measurement. Also the designs of processing equipment and accessories such as dies, molds, extrusion screws, and others require the true viscosity of the materials. However, the apparent viscosity measurement has been used for a quick test as an indication since it is easier and faster to measure and often more economical. The true viscosity is more difficult to get and can be only measured with a few types of instruments: rheometers and capillary viscometers. The rheometers impose a precise and known shear rate on test samples thereby measuring true viscosities. The rheometers are versatile and equipped to measure other properties. Therefore they are usually expensive. In addition, usually large amounts of samples are required for viscosity measurement with the rheometers. Also the rheometers are not well suited for on-line applications. Circular capillary viscometers are another type that can measure apparent and true viscosities depending on whether a proper compensation is taken into account. The capillary viscometer needs a pressure drop measurement along the capillary for viscosity. Since the capillary is circular, the capillary viscometer measures only apparent viscosity unless the entrance effect is corrected by using two different capillaries with different length-to-diameter ratios. However, use of two capillaries makes the viscometers bulky or makes viscosity measurements time-consuming. Residence time of a marker in a fluidic channel may be used to measure the viscosity, which is not a true viscosity unless the test liquid is Newtonian.

In conventional differential pressure capillary viscometers, as a test liquid flows through a capillary tube, pressure drop is measured with a differential pressure sensor. The pressure drop is proportional to the viscosity for a given flow rate. With this method, the pressure sensors do not make an intimate contact with the capillary and thus does not measure pressure right on the interior surface of the capillary. Such remote sensing poses two main problems. One problem is that the path connecting the capillary and the differential pressure sensor acts as a dead volume in which a prior sample could reside longer since it is difficult to clean the prior sample by a direct flow. The increased time for cleaning can also be a source of inaccuracy in viscosity measurement. In addition, the residue of the prior sample is also a source of contamination. Another problem is that a significant hole pressure can be generated if a test sample has a significant elasticity. Although reciprocating drive pump system and reciprocating capillary viscometer may be used to measure viscosity of a liquid semi continuously, such configurations also have the same limitations caused by the remote differential pressure measurement and the dead volume of the tube connecting the differential pressure sensor and the capillary.

In summary, most of viscosity measurement technique yield apparent viscosity and requires larger volume of sample. Therefore, there is a need for a viscometer which measures true and accurate viscosity for samples of small quantities in a rapid manner.

As described herein, a viscometer (or a viscometer sensor chip) that enables faster measurement may be limited to a certain dynamic range of measurable shear stress. If one needs to characterize the viscosity as a function of shear rate over wide shear rate range, multiple sensor chips with different dynamic ranges need to be used in combination. Utilizing multiple pumps in parallel or valves to switch from one chip to another requires more samples and/or time for measurement. Also a use of a single flow cell with a flow channel of different depths in series requires corresponding series of pressure sensor array to measure pressure drop in each flow channel. For this, pressure sensors with different degrees of full-scales need to be built. For example, the pressure sensor in the upstream of the cell should measure much higher pressure than that in the downstream of the cell since pressure in the upstream is much higher than that in the downstream. Pressure sensors with varying full-scale pressures can be built in a single monolithic array with microfabrication process of wafers. To measure viscosity in wide shear rate rage, the full-scale pressure of the pressure sensor in the upstream is much higher than the full-scale pressure of the pressure sensor in the downstream. However, in order to measure the pressure accurately, the pressure sensors in the array need to be calibrated. To calibrate, a controlled pressure is applied to all pressure sensors and responses of the pressure sensors are measured as capacitance change or resistance change. Since all pressure sensors are subject to the same pressure, full-scale pressures of the pressure sensors cannot differ significantly. If the full-scale pressures differ significantly, the pressure sensors with a low full-scale pressure in the down steam could be damaged. Therefore, this approach does not increase the dynamic range sufficiently.

Fluid formulations in a variety of industries are intentionally modified to adjust the viscosity to ensure application performance and processability. For example, the use of viscosity measurements in the formulation process is becoming increasingly popular in the pharmaceutical industry where a significant effort is made to identify excipients that reduce the viscosity of high concentration therapeutics. Quantities of samples are often limited in early-stage research, making low volume and efficient measurement techniques such as microfluidics valuable. Structure-property relationships long established in analogous colloidal systems can be employed to extend the benefits of viscosity measurements beyond the practical. Specifically, a characteristic length scale (L) reflecting the size of a cluster formed by inherently attractive proteins or antibodies can be extracted to assess the ability of excipients to modify interactions and reduce aggregation. This analysis requires the viscosity to be measured over a broad range of shear rates so that both the low shear plateau (ho) and the critical shear rate (\dot{γ}_{c}) corresponding to the onset of shear thinning can be obtained.

Utilizing viscosity measurements for a dual purpose minimizes the need to apply other analytical tools requiring additional sample volume and time. The most common complementary techniques providing interaction and microstructural information are the various types of scattering including light, x-ray, and neutron. Although dynamic light scattering (DLS) is often readily available, formulations must be diluted significantly to avoid multiple scattering and obtain properties such as the hydrodynamic radius or the diffusion interaction parameter (kD) used to categorize interactions as predominantly attractive or repulsive. Dilution is a cause for concern since both interactions and aggregation are expected to vary with active concentration. Therefore, the results may not accurately describe the behavior at concentrated or therapeutic levels. Small angle x-ray and neutron scattering (SAXS and SANS) can be performed on concentrated formulations but present other challenges. While bench top models exist for SAXS, higher quality data requires a synchrotron light source. Similarly, SANS must be performed at a neutron facility making both techniques less accessible. Identifying appropriate models and correctly interpreting their fit to the data is also a challenge for concentrated complex fluids. Reducing the use of such complementary techniques by more extensively analyzing viscosity data could conserve precious sample volume and development time.

In certain applications, viscosity measurement has been employed as a method to probe the extent of enzymatic reaction, since the viscosity measurement is a very sensitive to changes in the molecular weight by the enzymatic reaction. Enzymatic hydrolysis with Galactomannanase of Guar Galactomannan is one of the examples. In a typical set up for an enzymatic reaction, a mixture of an enzyme and a substrate is loaded in a temperature-controlled reaction chamber. As the reaction progresses, a sample is taken from the reaction chamber and the viscosity of the sample is measured to determine the extent of reaction. Therefore, an aliquot of sample is taken at each time interval from the chamber in order to monitor the progress of the reaction over time. In certain applications, the enzyme is deactivated in the aliquot before measuring the viscosity of the aliquot to prevent further reaction. This approach requires an operator to perform additional steps for each viscosity measurement. Also, in addition, typical viscometers require sample on the order of mL, which in turn requires a large volume of the mixture in the chamber to enable a series of viscosity measurements over time. The viscometers described herein address these challenges and limitations and additional challenges and limitations. For example, the viscosity sensor may be directly coupled to the syringe where the reaction takes place so that the sample from the syringe can be directly injected to the viscosity sensor for in-situ viscosity measurement. This allows continuous or semi-continuous viscosity measurement at preset durations. In addition, because the viscosity sensor chip requires a small volume of liquid (e.g., a few microliters), a reaction mixture having a small volume (e.g., 2.5 mL) can be used for reaction kinetic studies.

High throughput viscosity measurement has been growing in demand for formulation development in various industries. For example, high throughput viscosity measurement of mAb (mono clonal antibody) solution has been growing in biopharmaceutical industries in order to shorten development time of candidate drugs. In high throughput viscosity measurement made with a device including multiple flow channels in parallel, multiple samples are loaded into the inlets of the multiple channels and the times to reach certain target distance from the inlet are measured upon applying a constant pressure to the common port connected to the multiple inlets. The lower the viscosity of the sample is the faster the sample reaches the target distance. However, this method has a few drawbacks. One is that this method does not measure true viscosity. Also surface tension and surface wettability affect the viscosity measurement. Since controlling a consistent surface tension and wettability of the flow channels is difficult, this method suffers with lower accuracy and repeatability. This method also has a limited access to high shear rates.

This application describes viscometers that significantly increase the throughput of the true viscosity measurement with improved dynamic range as a function of shear rate overcoming the limitations of conventional viscometers. As described herein, a viscometer is equipped with multiple viscosity sensor chips and multiple test syringes with a single pumping mechanism.

### BRIEF DESCRIPTION OF THE DRAWINGS

For a better understanding of the embodiments described herein as well as additional embodiments, reference should be made to the Detailed Description below, in conjunction with the following drawings in which like reference numerals refer to corresponding parts throughout the figures.

FIG. 1 is a schematic diagram illustrating a viscometer that measures viscosities of multiple samples in a high throughput manner in accordance with some embodiments.

FIG. 2A is a schematic diagram illustrating a syringe for the high throughput viscometer in accordance with some embodiments.

FIGS. 2B and 2C are schematic diagrams illustrating a locking mechanism in closed and open positions in accordance with some embodiments.

FIG. 3 is a schematic diagram illustrating of a viscosity sensor chip in accordance with some embodiments.

FIG. 4 is a cross-sectional view of the viscosity sensor taken from line A-A shown in FIG. 3 in accordance with some embodiments.

FIG. 5 is a cross-sectional view of the viscosity sensor taken from line A-A shown in FIG. 3 in accordance with some other embodiments.

FIG. 6 is a schematic diagram illustrating a high throughput viscometer with multiple viscosity sensor chips and associated multiple syringes in accordance with some embodiments.

FIG. 7 is a schematic diagram illustrating an autosampler with multiple syringes for injection to the injection ports of the high throughput viscometer in accordance with some embodiments.

FIG. 8 is a schematic diagram illustrating a test syringe which has an injection port where a sample injection tube is connected for direct sample transport from other locations in accordance with some embodiments.

FIG. 9 is a schematic diagram illustrating a viscosity sensor chip which has multiple flow channels combined with appropriate pressure sensor arrays in series in accordance with some embodiments.

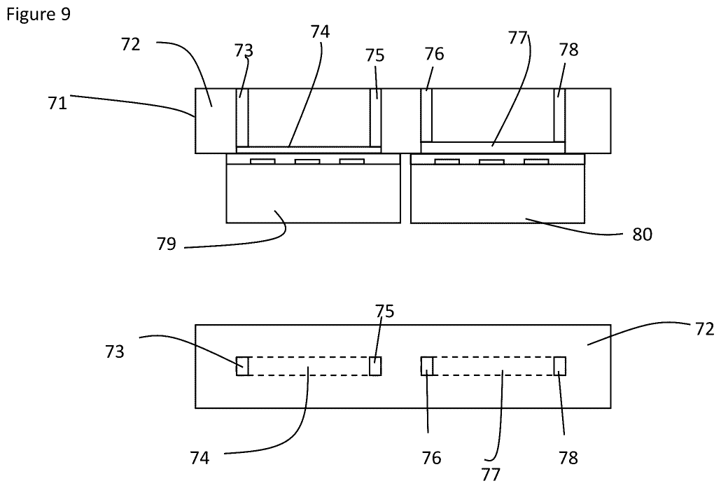

FIG. 10 is a schematic diagram illustrating a single syringe coupled with two viscosity sensor chips through a selection valve in accordance with some embodiments.

Drawings are not necessarily drawn to scale unless indicated otherwise.

### DETAILED DESCRIPTION

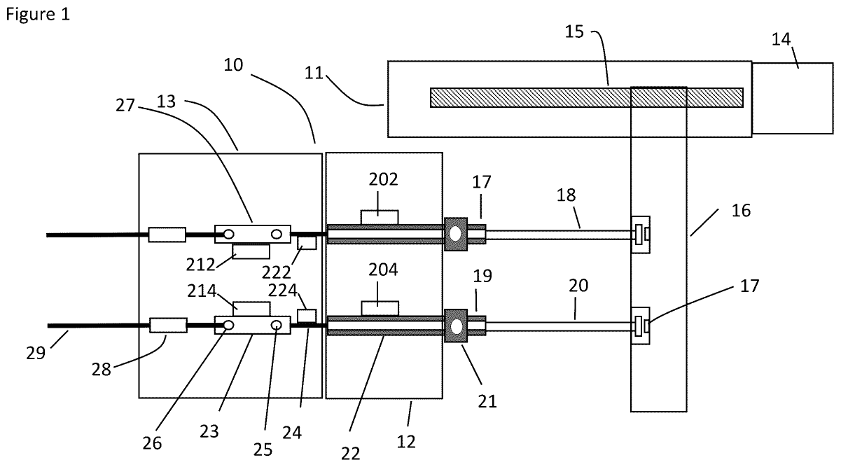

FIG. 1 is a schematic diagram illustrating a viscometer (10) that measures viscosities of multiple samples in a high throughput manner in accordance with some embodiments.

In FIG. 1, the high throughput viscometer (10) includes a pump system (11), a test syringe assembly (12), and a detection module (13). In some embodiments, the pump system (11) includes a motor (14) which rotates, a linear actuator (15) which converts the rotational motion of the motor (14) to a linear displacement, and a pusher block (16) which pushes syringe pistons (18, 20) at a same linear speed. In some embodiments, the pusher block (16) has cutouts where the ends of the pistons are cradled. In each cutout, in some embodiments, the pusher block also has sensors (17) that detect the contact of the end of the piston. In some embodiments, the sensor is a type of limit sensor which can detect the contact.

In some embodiments, the test syringe assembly (12) includes syringes (17, 19) and pistons (18, 20). In some embodiments, the syringes (17, 19) and/or the pistons (18, 20) are not included in the viscometer (10). In such embodiments, the viscometer (10) is configured to removably couple with the syringes (17, 19) and/or the pistons (18, 20) (e.g., the viscometer (10) may receive the syringes (17, 19) and the pistons (18, 20) for testing, and the syringes (17, 19) and/or the pistons (18, 20) may be removed subsequently).

In some embodiments, the syringe (19) has a barrel (22). In some embodiments, the syringe (19) has an injection port (21). In some embodiments, the detection module (13) includes an inlet tube (24) which connects the end of the syringe (19) with an inlet (25) of a viscosity sensor chip (23). In some embodiments, the detection module (13) includes a sample reservoir (28) which holds the sample leaving an outlet (26) of the viscosity sensor chip (23). In some embodiments, an outlet tube (29) is connected to a waste container and/or a pressure source. In configurations where the outlet tube (29) is connected to the pressure source, when the pressure source is activated, a sample held in the sample reservoir (28) is transported back to the test syringe (19) as the piston (20) is retracted. In some embodiments, the inlet tube (24) includes a sample preconditioning loop. This allows a test sample to be preconditioned to a test temperature (e.g., a temperature of the test sample is increased to a preset temperature) before entering the viscosity sensor chip. For example, in some embodiments, the viscometer (10) includes one or more temperature controllers (222, 224) positioned adjacent to inlet tubes (24) for controlling the temperature of a sample passed through the inlet tubes. In some embodiments, the viscometer (10) includes at least one temperature controller for each inlet tube. In some embodiments, the viscometer (10) includes temperature controllers for a subset, less than all, of the inlet tubes. In some embodiments, the viscometer (10) includes one or more temperature controllers (202, 204) positioned adjacent to the syringes (17, 19) for controlling the temperature of the syringes (17, 19). In some embodiments, the viscometer (10) includes at least one temperature controller for each syringe. In some embodiments, the viscometer (10) includes temperature controllers for a subset, less than all, of the syringes. In some embodiments, the viscometer (10) includes one or more temperature controller (212, 214) positioned adjacent to the viscosity sensor chips (23) for controlling the temperature of the viscosity sensor chips (and hence, pressure sensors located in the viscosity sensor chips). In some embodiments, the viscometer (10) includes at least one temperature controller for each viscosity sensor chip. In some embodiments, the viscometer (10) includes temperature controllers for a subset, less than all, of the viscosity sensor chips.

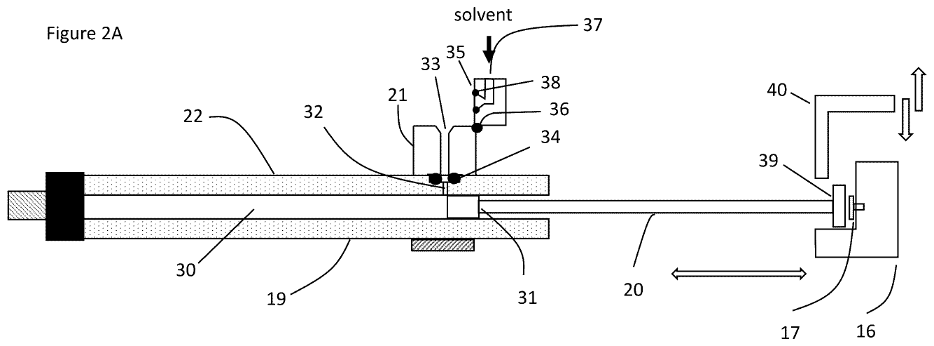

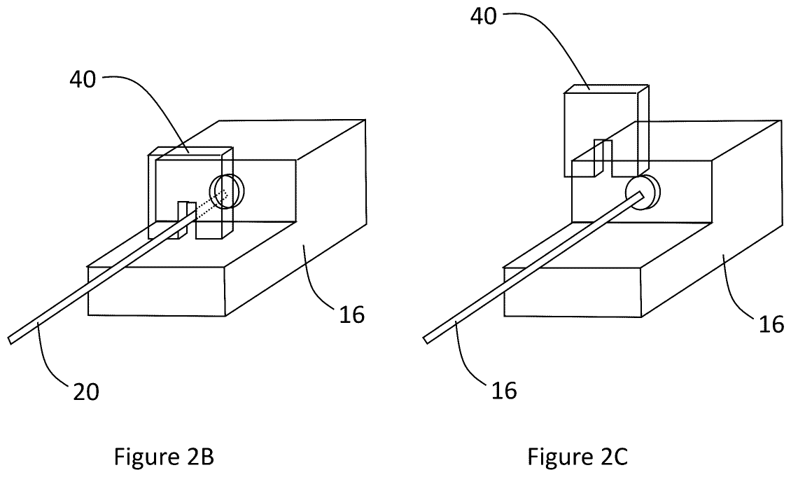

FIG. 2A is a schematic diagram illustrating a syringe for the high throughput viscometer in accordance with some embodiments.

In FIG. 2A, the test syringe (19) includes the injection port (21), the syringe barrel (22) and the syringe piston (20). When a seal (31) is at a position that an opening hole (32) in the barrel (22) is just open, as shown in FIG. 2A, a test sample is injected to an inlet port (33). The injected sample flows though the opening (32) and fills inside (30) of the barrel (22) during the sample injection step. As the pusher block (16) moves forward (leftward as illustrated in FIG. 2A) the detection sensor (17) detects the engagement of an end (39) of the piston (20). Upon engagement, a lock key (40) is lowered to lock the piston (as shown in FIG. 2B) so that the end (39) is locked in the pusher block (16). The lowering action is preferably activated by a solenoid, motor assisted, or pneumatic actuator than manual action. When the lock key (39) is raised (as shown in FIG. 2C), the piston (20) and the pusher block (16) is disengaged. In some embodiments, the pusher block (16) cannot pull the disengaged piston (20) when the pusher block (16) moves backward (rightward as illustrated in FIG. 2A). In some embodiments, after the test sample is injected into the test syringe (19), a cap (35) of the injection port is closed. In some embodiments, the syringe includes a hinge (36). In some embodiments, the hinge (36) facilitates the open and close of the cap (35). In some embodiments, the syringe includes an O ring (38). In some configurations, the O ring (38) reduces or eliminates leak when the cap (35) is closed. In some embodiments, the cap (35) has a side port (37) though which a cleaning solvent and air can be fed for cleaning and drying after the viscosity measurement is completed.

As explained above, FIGS. 2B and 2C illustrate a locking mechanism in closed (or locked) and open (unlocked) positions in accordance with some embodiments. Although FIGS. 2B and 2C illustrate a locking mechanism locking a single piston (or a plunger thereof), the locking mechanism may be modified to lock multiple pistons (or plungers thereof). For example, in some configurations, a wide lock key with multiple slots is placed to lock and unlock multiple pitons concurrently. For brevity, such details are not repeated herein.

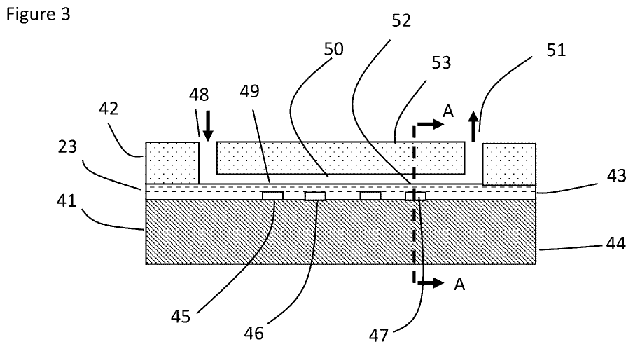

FIG. 3 is a schematic diagram illustrating of a viscosity sensor chip in accordance with some embodiments.

In some embodiments, as shown in FIG. 3, the viscosity sensor chip (23) includes a MEMS sensor array (41) and the flow channel (42) combined as described in U.S. Pat. No. 7,290,441, which is incorporated by reference herein in its entirety. The flow channel (42) includes an inlet (48), a straight flow path (50), and the outlet (51). The flow channel is typically made of a glass. In some embodiments, the MEMS sensor array (41) includes a silicon membrane (43) and the glass substrate (44). In some embodiments, cavities are etched in the silicon to form capacitive pressure sensors (45, 46, 47). In some embodiments, the pressure inside of the cavity is open to ambient so that the pressure sensors measure gauge pressure. In some configurations, as a test liquid flows through the straight flow path (50), pressure gradient is induced along the flow direction and the pressure deflects the silicon membranes (49, 52) over the cavities (45, 47).

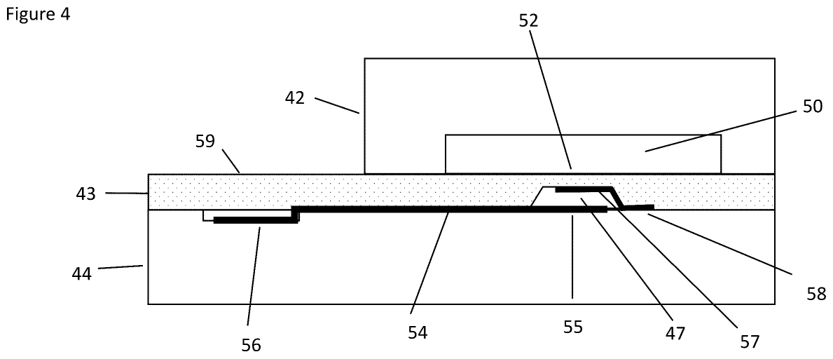

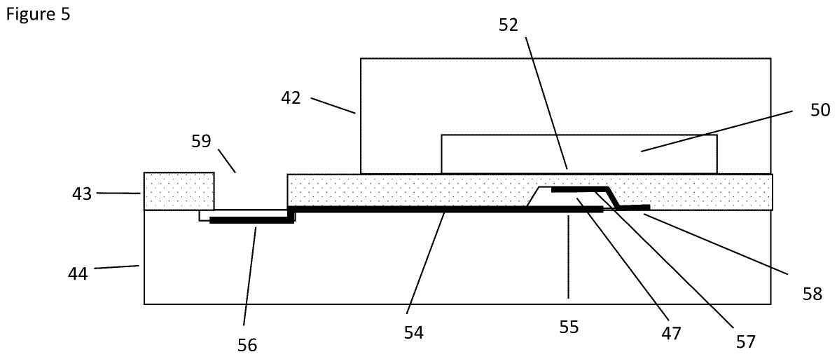

FIG. 4 shows a cross-sectional view of the viscosity sensor chip (23) along the cut line A-A shown in FIG. 3, in accordance with some embodiments. As the pressure inside of the flow path (50) builds due to flow, the silicon membrane (52) over the cavity (47) deflects. As the membrane (52) deflects, the gap between the top capacitor electrode (57) and the bottom capacitor electrode (55) decreases resulting into an increase in capacitance. The bottom capacitor electrode (55) is traced to the bond pad electrode (56) through a lead (54). Similar way, the top capacitor electrode (57) is traced to the other bond pad electrode (omitted so as not to obscure other aspects of the embodiment) through a lead (58). The viscosity sensor chip (23) in FIG. 4 is inactivated since the bond pad electrode (56) is hidden under the silicon (59). In order to activate the viscosity sensor chip (23), the silicon membrane (59) over the bond pad electrode (56) needs to be removed as shown in FIG. 5. The exposed bond pad electrode can be connected to the capacitance measuring chip. In some embodiments, the measured capacitance is converted back to the pressure once pressure vs. capacitance relationship is known.

Referring back to FIG. 1, in some embodiments, as the pusher block (16) moves to the piston, the detection sensor (17) continues to monitor the contact of the end (39) of the piston (20). When the detection sensor (17) detects the end, then the pusher block (16) stops and the lock key (40) is lowered to lock the piston with the pusher block. Then the pusher block moves to the open position so that the seal (31) of the piston is just behind the opening (32) of the barrel (22). Then the cap (35) is open so that test samples can be injected to the inlet port (33). After injection is completed, the piston moves forward to close the opening (32) and then the cap (35) is closed. After the samples are loaded into the syringes (17, 19), the high throughput viscometer (10) is ready for viscosity measurements. If a temperature control is needed, in some embodiments, the test syringe assembly (12) and the detection module (13) are controlled independently.

### Example 1: Measurement of Viscosity of Samples Having Similar Viscosities in Similar Ranges of Shear Rates

To measure viscosities of samples having similar viscosity in the similar range of shear rate, in some embodiments, syringes (17, 19) having a same size (e.g., volume) and the viscosity sensor chips (23, 27) of a s same type are combined for the high throughput viscometer (10). As the pusher block (16) moves forward (leftward in FIG. 2A), the flow rate is varied so that viscosities at different shear rates can be measured. The shear rate can be calculated using the equation below.

$$\dot{γ} ( shear rate ) = \frac{6 \times flow}{{wh}^{2}}$$

w is the width of the flow channel and h the depth of the flow channel. If further viscosity measurement is needed even after the syringe load of sample is consumed, the sample can be retrieved back to the syringe by moving the pusher block backward (rightward in FIG. 2A) while a positive pressure is supplied to the outlet tubes (29).

### Example 2: Measurement of a Viscosity for a Sample with a Wide Range of Shear Rates

To measure viscosity of a sample at wide shear rates, different sizes of syringes are employed. For example, the size of the syringe (17) is 100 μL and the size of the syringe (19) is 500 uL. With this combination, shear rate of the 500 uL is 5 times as high as that of 100 uL syringe for a given speed of the pusher block (16). Also, the viscosity sensor chip (23) has a higher full-scale pressure than that of the viscosity sensor chip (27). Shear stress is correlated to the pressure (P) as follows:

$$τ = \frac{Ph}{2 L}$$

where L is the length of the flow channel. The equation clearly states that higher full-scale pressure chip can measure higher shear stress (t).

$$τ = viscosity \times \dot{γ}$$

The viscosity sensor chip with higher full-scale pressure can measure higher shear stress and higher shear rate for a given viscosity. Since the minimum shear stress the chip can measure is a fraction (typically 2%) of the maximum shear stress, the viscosity sensor chip with higher full-scale pressure can measure higher shear rate range accurately whereas the viscosity sensor chip with smaller full-scale pressure measures lower shear rate range accurately. Thus the combination of a low full-scale pressure viscosity sensor chip (27) coupled with small size syringe (17) and high full-scale pressure viscosity sensor chip (23) coupled with large volume syringe (19) can measure wider shear rate ranges with higher accuracy and speed. However, during measurement, one of the viscosity sensor chip can reach the full-scale pressure at earlier shear rate than the other chip. In this case, the syringe coupled with the chip that reaches the full-scale earlier is disengaged after the piston is moved to the full dispense position or left most position. The piston can be disengaged by raising the lock key (40) of associated syringe. In this way, the viscosity measurement can continue at higher shear rates without damaging the chip that reaches the full-scale pressure at lower shear rates.

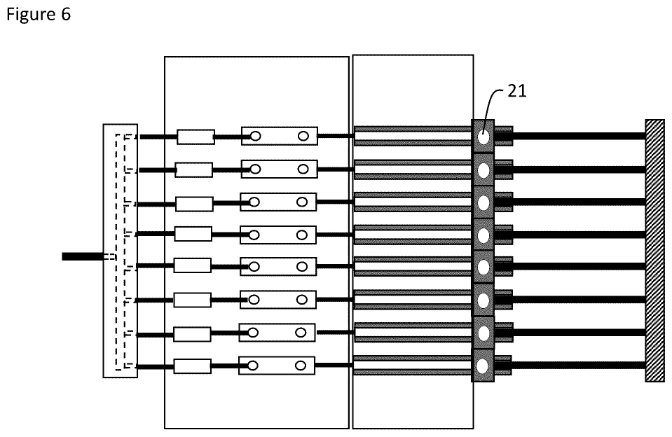

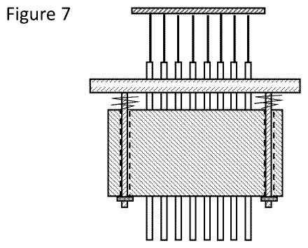

The high throughput of the viscosity measurement can be increased linearly with the increase the number of the viscosity sensor chip and the associated syringe as shown in FIG. 6. The test samples can be manually injected to each injection port or injected with an autosampler with multiple injection syringes as shown in FIG. 7. After the samples are tested, cleaning solvents are fed to the side port (37) of the cap (35) to clean the wetted paths and air is supplied to dry.

### Example 3: A High Throughput Viscosity Measurement without Requiring the Cleaning and Drying

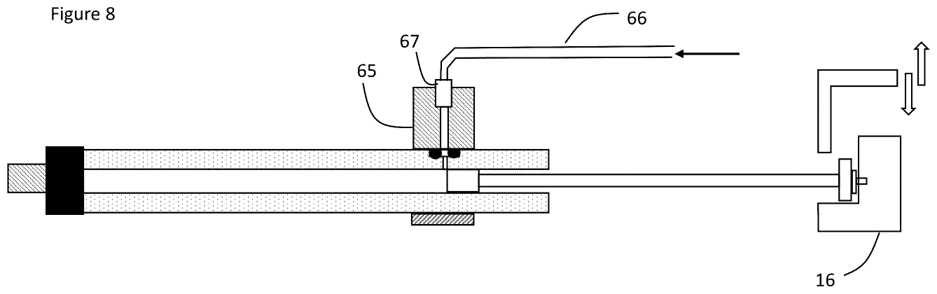

The high throughput viscosity has a small swept volume of the flow paths, which makes possible to clean the wetted paths with small volume of the sample. When the wetted paths are filled with previous test samples, the paths can be cleaned with the new sample. Since the swept volume is small in the order of a few hundred microliter, a few mL of the new sample should be enough to replace the previous sample. As shown in FIG. 8, the injection port (65) has a feed tube (66) which is connected to the injection port (65) with a fitting (67). A test sample is pumped to feed to the feed tube (66). One way to pump sample is to immerse the receiving end of the feed tube (66) into a sample in a sealed vial. When the pressure inside of the vial increases, sample starts flowing into the feed tube (66). After a sufficient volume of the test sample is fed, pump is stopped. Then viscosity measurement starts by moving the pusher block (16) forward (left). After the measurement is finished, the pusher block (16) is moved backward (right) with the assistance pressure applied to the outlet tube (29) to the open position so that the next sample can be fed for testing. Removing the cleaning and drying steps reduce the measurement time significantly so that each sample takes about 1 minute for the viscosity measurement.

To further increase the throughput of viscosity measurement of samples for which viscosity needs to be measured at different shear rates, a differently configured viscosity sensor chip (71) can be used. As shown in FIG. 7, the chip (71) includes a single flow channel (72) where a multiple flow channels (74, 77) with different flow channel depths and multiple pressure sensor arrays (79, 80) with different full-scale pressures. In some configurations, the pressure sensors in the array (79) have much greater full-scale pressures than those of the pressure sensors in the array (80). The depth of the flow channel (74) is roughly half of that of the flow channel (77). A test liquid enters the inlet (73) and exits the outlet (75). The exited liquid then enters the inlet (76) and exits the outlet (78). Combination of a pressure sensor array and the flow channel depth allows the viscosity measurement of a sample at two different shear rates for a given flow rate as the test sample flows in the chip (71). With the chip (81), total measurement time can be reduced by half. Measurements of pH, density, or conductivity can be added in series with the viscosity sensor chip to measure multiple properties of test liquids simultaneously.

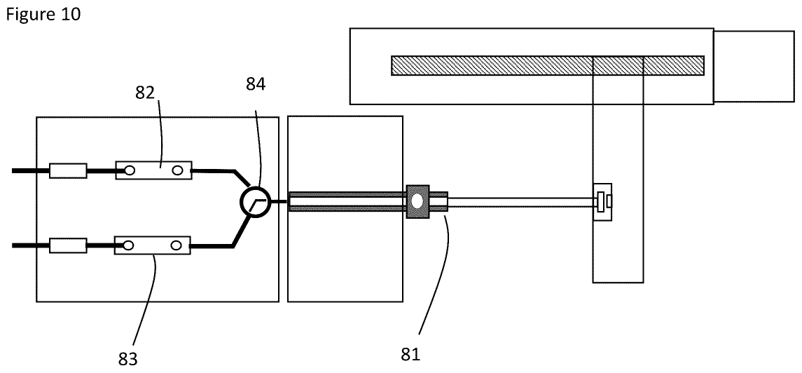

Alternatively, multiple viscosity sensor chips (82, 83) can be coupled with each syringe (81) through a selection valve (84), as shown in FIG. 10. For example, a low shear rate can be measured with the viscosity sensor chip (82) when the selection valve connects the viscosity sensor chip (82) with the syringe (81). When the selection valve connects the viscosity sensor chip (83) with the syringe, a higher shear rate range can be measured.

### Example 4: In-Situ Monitoring of the Enzymatic Degradation of Substrates

Mixture of a sample and an enzyme is loaded into the test syringe (22). At t=0, enzymatic reaction starts. As the reaction progresses, the substrate is hydrolyzed into smaller molecules and the viscosity of the sample decreases. The viscosity of the sample is measured at an interval with the viscosity sensor chip (23). In some embodiments, a switching valve is located between the test syringe (22) and the viscosity sensor chip (23) in order to isolate the reaction chamber from the downstream viscosity sensor. In some embodiments, the syringe (22) and the viscosity sensor chip (23) are maintained at different temperatures. For example, the reaction takes places at a temperature higher than the viscosity measurement temperature. Since only a small sample volume (˜a few microliters) is used for each viscosity measurement, a large initial sample volume is not needed. In some embodiments, a combination of multiple syringes and multiple viscosity sensor chips is employed. The use of a combination of multiple syringes and viscosity sensor chips allows simultaneous measurements for various reaction conditions. For example, such combination may be used for determining the effect of different initial reaction conditions, such as the ratio of enzyme concentration to the substrate.

In view of these examples and principles, we turn to certain embodiments.

(A-1) In accordance with some embodiments, a viscometer includes multiple viscosity sensors with liquid flow channels for measuring viscosities of liquids flowing through the flow channels; multiple syringes, each outlet of which is connected to a corresponding inlet of multiple viscosity sensors; and a pump module with a pusher block having a mechanism to lock and unlock ends of pistons of the multiple syringes.

(A-2) In some embodiments, in the viscometer of (A-1), the multiple syringes include injection ports through which test samples are injected.

(A-3) In some embodiments, in the viscometer of (A-2), the injection ports are configured to receive test samples from an autosampler.

(A-4) In some embodiments, in the viscometer of (A-2), the injection ports are configured to receive test samples pumped directly from a sample container.

(A-5) In some embodiments, the viscometer of any of (A-1) through (A-4) includes a sample preconditioning loop located before each viscosity sensor.

(A-6) In some embodiments, the viscometer of any of (A-1) through (A-5) includes a reservoir immediately after each viscosity sensor.

(A-7) In some embodiments, in the viscometer of any of (A-1) through (A-6), the locking or unlocking mechanism is automatically (e.g., independent of a manual user input or operation) and selectively (e.g., independently of activation for any other syringes) activated for each syringe.

(A-8) In some embodiments, the viscometer of any of (A-1) through (A-7) includes a pressure supply coupled to an exit of a respective viscosity sensor to facilitate sample retrieval.

(A-9) In some embodiments, the viscometer of any of (A-1) through (A-8) includes a substrate defining an inlet, a flow channel, and an outlet; and a pressure sensor array built between one or more layers of a silicon and the substrate.

(A-10) In some embodiments, in the viscometer of any of (A-1) through (A-9), the flow channel and the pressure sensor array are at least partially bonded to each other.

(A-11) In some embodiments, in the viscometer of any of (A-1) through (A-10), the multiple viscosity sensors are connected in series.

(A-12) In some embodiments, the viscometer of any of (A-1) through (A-11) includes a plurality of viscosity sensors coupled with a single syringe.

(A-13) In some embodiments, the viscometer of any of (A-1) through (A-12) includes a first temperature controller for the multiple viscosity sensors.

(A-14) In some embodiments, the viscometer of (A-13) includes a second temperature controller for the multiple syringes.

(A-15) In some embodiments, in the viscometer of (A-14), the first temperature controller is configured to maintain the multiple viscosity sensors at a first temperature and the second temperature controller is configured to maintain the multiple syringes at a second temperature independently of the first temperature.

(A-16) In some embodiments, in the viscometer of (A-15), the second temperature is distinct from the first temperature.

(A-17) In some embodiments, in the viscometer of (A-14) or (A-15), the first temperature controller and the second temperature controller are distinct from each other.

(A-18) In some embodiments, in the viscometer of (A-14) or (A-15), the first temperature controller and the second temperature controller are integrated with each other.

(A-19) In some embodiments, in the viscometer of (A-14), the second temperature controller is configured to maintain the multiple syringes at a first temperature at a first time and maintain the multiple syringes at a second temperature distinct from the first temperature at a second time mutually exclusive to the first time.

(B-1) In accordance with some embodiments, a method includes providing a sample into a syringe, wherein the sample satisfies a condition for a chemical or biological reaction; measuring a viscosity of at least a portion of the sample using a viscometer fluidically coupled with the syringe; and determining an extent of the reaction based on the measured viscosity.

(B-2) In some embodiments, in the method of (B-1), the sample is deemed to satisfy the condition for the chemical or biological reaction when the sample contains a mixture of an enzyme and a substrate.

Thus, the viscometers described in this application can expedite process development and save development costs.

What is claimed is:

1. A viscometer, comprising:
multiple viscosity sensors with liquid flow channels for measuring viscosities of liquids flowing through the flow channels;
multiple syringes, each outlet of which is connected to a corresponding inlet of multiple viscosity sensors; and
a pump module with a pusher block having a mechanism to lock and unlock ends of pistons of the multiple syringes.

2. The viscometer in claim 1, wherein the multiple syringes include injection ports through which test samples are injected.

3. The viscometer of claim 2, wherein the injection ports are configured to receive test samples from an autosampler.

4. The viscometer of claim 2, wherein the injection ports are configured to receive test samples pumped directly from a sample container.

5. The viscometer of claim 1, including a sample preconditioning loop located before each viscosity sensor.

6. The viscometer of claim 1, including a reservoir immediately after each viscosity sensor.

7. The viscometer of claim 1, wherein the locking or unlocking mechanism is automatically and selectively activated for each syringe.

8. The viscometer of claim 1, including a pressure supply coupled to an exit of a respective viscosity sensor to facilitate sample retrieval.

9. The viscometer of claim 1, including:
a substrate defining an inlet, a flow channel, and an outlet; and
a pressure sensor array built between one or more layers of a silicon and the substrate.

10. The viscometer of claim 9, wherein:
the flow channel and the pressure sensor array are at least partially bonded to each other.

11. The viscometer of claim 1, wherein the multiple viscosity sensors are connected in series.

12. The viscometer of claim 1, including a plurality of viscosity sensors coupled with a single syringe.

13. The viscometer of claim 1, further comprising:
a first temperature controller for the multiple viscosity sensors.

14. The viscometer of claim 13, further comprising:
a second temperature controller for the multiple syringes.

15. The viscometer of claim 14, wherein the first temperature controller is configured to maintain the multiple viscosity sensors at a first temperature and the second temperature controller is configured to maintain the multiple syringes at a second temperature independently of the first temperature.

16. The viscometer of claim 15, wherein the second temperature is distinct from the first temperature.

17. The viscometer of claim 14, wherein the first temperature controller and the second temperature controller are distinct from each other.

18. The viscometer of claim 14, wherein the first temperature controller and the second temperature controller are integrated with each other.

19. The viscometer of claim 14, wherein the second temperature controller is configured to maintain the multiple syringes at a first temperature at a first time and maintain the multiple syringes at a second temperature distinct from the first temperature at a second time mutually exclusive to the first time.

20. A method, comprising:
providing a sample into a syringe, wherein the sample satisfies a condition for a chemical or biological reaction;
measuring a viscosity of at least a portion of the sample using a viscometer fluidically coupled with the syringe; and
determining an extent of the reaction based on the measured viscosity.
